(19) United States
(12) Patent Application Publication
(10) Pub. No.: US 2009/0117356 A1
(43) Pub. Date: May 7, 2009

(54) High temperature substrate protective structure

(76) Inventors: Tim Hsu, State College, PA (US); David Berry, San Antonio, TX (US); George I. Butler, Kingwood, TX (US)

Correspondence Address: MCQUAIDE BLASKO, 811 UNIVERSITY DRIVE, STATE COLLEGE, PA, 16801, US

(21) Appl. No.: 12/290,531

(22) Filed: Oct. 31, 2008

Related U.S. Application Data
(60) Provisional application No. 61/001,689, filed on Nov. 2, 2007.

(51) Int. Cl. B32B 7/02; B32B 37/00

(52) U.S. Cl. 428/212; 156/60

(57) ABSTRACT

Substrate protective structures, including high performance polymers and polymer coatings from 1 to over 2500 mils thick, are disclosed. The structures protect metal and other surfaces with heat resistant, abrasion resistant, and chemical inert polymers. The structures are applied to the substrate in a manner that provides easy processing of curved and bent surfaces, increased adhesion of metal to polymer, greater resistance to mechanical and thermal stresses that cause cracking and de-lamination, and increased environmental resistance.

### RELATED APPLICATIONS

This application claims priority to U.S. Provisional Patent Application No. 61/001,689, filed Nov. 2, 2007.

### INTRODUCTION

The present teachings relate to substrate protective structures, including novel high performance polymers and polymer coatings from 1 to over 2500 mils thick. The present teachings also relate to the protection of metal surfaces-with heat resistant, abrasion resistant, and chemical inert polymers, and to a structure for intimately bonding these polymers to metal in a manner to provide: (1) easy processing of curved and bent surfaces; (2) increased adhesion of metal to polymer; (3) greater resistance to mechanical and thermal stresses that cause cracking and de-lamination; and (4) increased environmental resistance.

A thermoplastic is defined as a material which repeatedly softens when heated above and hardens when cooled below its melting point. Examples of thermoplastics include polyphenylene sulfone (PPSU), polyetherimide (PEI), polyvinylidene difluoride (PVDF), polyethylene chlorotrifluoroethlyene (ECTFE), polyetheretherketone (PEEK), and polyetherketoneketone (PEKK).

When polymers solidify by cooling from melting, they can remain amorphous or crystallized to some extent. Polymers that partially crystallize are referred to as semi-crystalline. Reaction chemistry, processing and/or additives can significantly speed up or retard the degree and/or rate of crystallization. For example, reaction chemistry during resin synthesis can produce PEKK resin that is either easy to crystallize (C-PEKK), or one that stays amorphous under most environments (A-PEKK).

As a rule, high temperature, rigid, semi-crystalline, aromatic polymers such as polyphenylsulfide (PPS), PEEK and C-PEKK have ideal properties for severe service conditions in harsh chemicals, high temperatures, and abrasive environments; however, they are extremely difficult to process as coatings because they have very narrow processing windows, are limited to very simple part geometries, and have poor, long durability even in benign environments. These problems are caused by high melt temperatures which cause stresses during processing due to a mismatched coefficient of thermal expansion (CLTE) between the polymer and metal, high shrinkage caused by crystallization coupled with low elongation which causes cracking, pin holing, poor adhesion, and de-lamination.

Amorphous polymers such as polyphenylenesulfone (PPSU), polyetherimide (PEI), and A-PEKK are bondable to metals and have good durability due to a wide processing window, wide softening point, low shrinkage, higher ductility, and superior adhesion to metal surfaces; however, these polymers tend to exhibit poor abrasion resistance as compared to semi-crystalline polymers.

Thus, no known single polymer or compound in the art offers all of the desired properties of heat resistance, abrasion resistance, chemical inertness, superb adherence, ease of processing, and high durability in field use.

### SUMMARY

The present teachings are directed to a system which combines the beneficial properties of high temperature, semi-crystalline, low elongation polymers with the processing ease of high temperature, amorphous, high elongation polymers. The benefits of a layered A-PEKK/PEEK film coating system (as defined herein) are shown for pipe coatings and are compared against the performance of a monolayer PEEK coating. The Structure (as defined herein) resulting from the present teachings offers exceptional coating quality around bends, curved surfaces, and large surfaces which have previously been unattainable.

The benefits of the present teachings include the following:
1. Production of a durable coating from a semi-crystalline polymer, such as PEEK, that would normally be difficult to process and would normally show a high tendency to de-lamination and cracking.
2. Improved coating quality as seen through the production of a pin hole free coating at lower coat weight. Pin hole free coatings improve electrical insulation and reduce metal corrosion by solvents and gases in the operating environment.
3. Vastly improved processability particularly on concave surfaces.
4. Improved coating adhesion to metal in all geometries as seen by resistance to cracking from bending coating-metal structure compared to a monolayer coating or multiple layer coating consisting of a polymer or polymers of higher shrinkage.
5. Inseparable adhesion between coating layers. For example, PEEK and A-PEKK bond intimately at the polymer-polymer interface and will not separate due to thermal or mechanical shock.
6. The Structure allows for the CLTE mismatch between the metal substrate and the coating.
7. The Structure can be applied to two or more similar polymers, polymer blends, or polymer compounds that differ in shrinkage and abrasion resistance, but have similar thermal and chemical resistance, permeation to solvents and gases, and processing conditions.

### BRIEF DESCRIPTION OF THE DRAWINGS

The skilled artisan will understand that the drawing(s) described below are for illustration purposes only. The drawing(s) are not intended to limit the scope of the present teachings in any way.

FIG. 1 depicts the “Structure” of the instant invention, including its constituent parts of the Substrate, Base Layer and Top Layer.

### DESCRIPTION OF VARIOUS EMBODIMENTS

In accordance with the present teachings, a structure comprising a thermoplastic film from 1 to 2500 mil are used to protect metals and other substrates through, for example, coating, molding, and lining applications. These protective films provide a cost effective method to reduce or eliminate corrosion and abrasion of metals components. These films can be applied to a wide range of component geometries and sizes such as cylinders, vessels, pipes, flanges, and augers. Substrates can be protected using several techniques such as dispersion coating, electrostatic coating, fluidized bed, blow, flame spray, and plasma coating. Molding and extrusion melt the structure directly onto a metal or other substrate (e.g., roto-molding). Linings are created by producing a film, tube, or pipe and then affixing the lining to the pipe through a secondary step that usually involves heat and/or pressure to bond the lining to the metal.

The present teachings comprise a multi-layer, substrate protective structure suitably designed to derive the maximum benefit from constituent components of the composite layers. The present teachings exploit the counter balancing benefits of at least two separate materials, where one material has higher elongation, lower shrinkage, lower abrasion resistance, and lower crystallinity than the other material.

As used herein, “the Substrate” refers to a metal or other surface to which the structure of the present teachings is applied. The metal includes ferrous metals such as carbon steel or stainless steel, and non-ferrous metals such as aluminum or titanium. The Substrate can also refer to a metal processed with a Coupling Agent.

As used herein, a “Coupling Agent” describes an inorganic layer that is used to treat a metal (e.g., by painting or coating). In some embodiments, the Coupling Agent is thin or very thin, comprising a thickness of approximately 0.5 mil or less. This layer chemically reacts with functional groups on the metal to create a permeation barrier against both solvents and gases. The Coupling Agent can either inhibit oxidation of the metal during processing or reduce metal corrosion and solvent and gas permeation to the metal through a polymer coating during field use. Coupling agents such as high temperature silanes are cured onto the metal either by heating to a temperature between about 90° F. and 140° F. for 1 hour or by being left to age at room temperature for about 24 hours.

As used herein, “Polymers” include all thermoplastics that have a melting point over about 550° F. and have a UL RTI rating of not less than about 450° F. The families of polyimides, polysulfones/sulfides, aromatic polyetherketones (PAEK) are examples. Examples of polyimides include PEI, thermoplastic polyimide (TPI), and polybenzlmidazole (PBI). Examples of polysulfones/sulfides include polyphenylene sulfide (PPS), polyphenylene sulfone (PPSO₂), polyethersulfone (PES), and PPSU. Examples of PAEK polymers include: PEEK, PEKK, PEK, PEKEKK, and PPEK.

Different Polymers are usually difficult to directly and permanently bond to one another. The exception are Polymers which share similar melting temperatures, melt stabilities, thermal resistance to oxidation, chemical resistance, physical strength and have strong affinities toward each other. These Polymer combinations form intimate and inseparable bonds between the interfaces between the two or more polymers upon melting of all the Polymers in the mixture.

Thus, as used herein, “Compatible” refers to Polymers with these characteristics, and, in addition, Compatible Polymers also show complete or partial miscibility. Miscibility can be identified by thermal transitions such as the glass transition temperature(s) (Tg), where the Tg of the mixture shifts towards the Tgs of the components Polymers. In some embodiments, Compatible Polymers have: (1) melt temperatures which differ by no more than about 150° F., (2) tensile strengths at room temperature which differ by up to about 50%, and (3) elongations at room temperature which differ by up to about 200%. Tensile strength and elongation can be measured by Test Method ASTM D 882A. Members of the same Polymer familty are referred to as Compatible Polymers. For example, A-PEEK and PEEK; A-PEEK and C-PEKK, PEEK and PEK; PEK and PEKEKK; and PEEK and PEI are Compatible Polymers.

As used herein, “Blend” refers to a mixture of two or more Polymers. A Blend may contain Compatible or Non-Compatible Polymers. Examples of Blend Polymers include mixtures of PEEK and PEI (PEEK/PEI), PEEK/PEI/PES, and PEEK/PPS.

As used herein, “Compound” refers to a Polymer mixed with any inorganic filler or a Polymer Blend mixed with any inorganic filler which remains in the coating after processing up to about 40 w/w % filler. Examples of Compounds include mixtures of PEEK and 5% glass powder (PEEK/5% glass powder), PES/5% ceramic powder, and PEKK/PI/7% mica. Fillers having greater than about 40 w/w % generally produce materials which are too brittle and difficult for bonding.

As used herein, “System” refers collectively to a Polymer, Blend, or Compound.

As used herein, “Shrinkage” refers generally to the dimensional change a System undergoes from melt to solidification and, in the case of semi-crystalline polymers, through crystallization. The Shrinkage of amorphous Polymers is very low relative to Polymers which crystallize, specifically, it refers hereto to the degree of crystallinity exhibited by the materials utilized in Coats. The higher the crystallinity of a Polymer, the higher the Shrinkage from melt. For instance, A-PEKK has a crystallinity of less than 15%, and preferably less than 10%, while PEEK has a crystallinity of generally between 25% and 30%.

As used herein, “Coat” refers to a Layer within the Film which has been built up by one process cycle(s). A cycle for dispersion, electrostic, blow, and fluidized bed would be marked by one heat cycle in the oven which is used to provide heat to melt, flow, and consolidate the System into a continous, pin hole-free surface. Each Coat should be Compatible with the previous and, when present, the subsequent Coat.

As used herein, “Film” refers to the total number of Coats created during processing and comprises at least two Layers—Base and Top—and may also comprise an Additional Layer.

As used herein, “Structure” refers to the Film attached to the Substrate.

As used herein, “Layer” comprises one or more Coats of the System.

The Top Layer is attached to the Base Layer (e.g., by bonding) and comprises a first Coat. The first Coat of the Top Layer is of a different composition than the last Coat of the Base Layer. In some embodiments, the first Coat features higher chemical and abrasion resistance than that of the Base Layer.

The Base Layer lies subjacent the Top Layer and comprises at least one Coat which demonstrates better adherence to the Substrate than any single Coat of the Top Layer. More specifically, the Base Layer contains the Coat that is attached to the Substrate.

In some embodiments of the present teachings, the Base Layer is distinguished by having an overall composition that has at least about 2% lower Shrinkage, and more preferably 2% lower crystallinity, as well as higher elongation to break, and lower abrasion resistance than the Coat(s) which comprises the Top Layer. Abrasion resistance between each Layer can be measured by the weight loss/cycle from a Taber Abrasion test (ASTM D 4060). The lower the mass/loss is per cycle, the higher the abrasion resistance.

By utilizing a Film comprising a Base Layer and a Top Layer, Structures are produced which allow for significantly easier processing of Substrates with concave surfaces, such as pipes. Moreover, this design creates Structures that are more resistant to failure from thermal and mechanical stresses like severe thermal cycles, vibration, bending, and abrasion. This is to be contrasted with Structures that use a Film composed of any single Coat from the Structure.

As used herein, “Base Layer” refers to Coat(s) which comprise the following Systems, or variation thereof known to those skilled in the art: A-PEKK, PEI; blends of PEI/PES, A-PEKK/TPI, A-PEKK/PBI, PEEK/PEI//PES, A-PEKK/PEEK; and compounds of A-PEEK/5% glass powder and PEEK/PEI/5% mica. These Systems create Coats that are amorphous or Coats comprised of a semi-crystalline Polymer Blend that has reduced crystallinity and higher elongation compared to the major semi-crystalline Polymer alone. The elongation to break for all of these Systems is in excess of about 50%. The crystallinity of these examples is less than 15%, and more preferably less than 10%. Since these materials are either amorphous or have very low crystallinity, these examples have relatively poor abrasion resistance compared to the examples provided below for the Top Coat. For example, the abrasion resistance of PEEK is at least 100% better than A-PEKK under most conditions.

As used herein, “Top Layer” refers to Coat(s) which comprise the following Systems, or variation thereof known to those skilled in the art: PEEK, C-PEKK; Blends of PEEK/C-PEKK, C-PEKK/PBI, PEEK/PBI; and Compounds of PEEK/glass fiber and PEK/ceramic spheres. These Systems are utilized to create Coats that are semi-crystalline or Coats comprised of a semi-crystalline Polymer Blend that has increased crystallinity and lowered elongation compared to the major semi-crystalline Polymer alone. These Systems have elongation to break below about 45% and have crystallinity greater than about 15%. The Systems comprising the Top Layer have Shrinkage greater than any of the Systems provided for Base Layers described above.

In some embodiments, the Top Layer or Base Layer of the Film can comprise Coats that are of identical composition or varying composition, provided that each Coat is Compatible with the previous and, when present, the subsequent Coat. For example, a Base Layer can comprise one or more Coats of A-PEKK. A Base Layer can also comprise one or more Coats of A-PEKK and one Coat of PEEK/PEI. In some embodiments, the Top Coat can be one or more Coats of PEEK or PEEK Compound.

When the multilayer Film of the present teachings is produced by coating, at least the first Coat of the Base Layer is preferably made from a System which produces a superior Coat quality compared with any other Coat. (See, for example, the Base Layer Systems described above.) For instance, Base Layer made from a Coat of A-PEKK shows superior coating quality to a Baser Layer made from a single Coat of PEEK, even when the powder size and molecular weight of each Polymer are the same. The A-PEEK melts into a continuous coating, in one pass, at Coat weights as low as 4-5 mils thick; whereas a continuous coating of PEEK can not be achieved in a single Coat. PEEK can be applied up to 7 mils thick per pass and will not form a continuous coating until at least about 8-10 mils is deposited onto the Substrate. Another advantage of A-PEKK over PEEK as a Base Layer is that since A-PEKK has a lower shrinkage than PEEK, the A-PEKK solidifies onto concave surfaces and features, such as the inside surface of a pipe, without loss of adhesion after solidification from the melt. PEEK crystallizes after solidification from the melt and tends to delaminate, create large voids, and crack from concave surfaces.

The amount or ratio of Base Layer to Top Layer that is employed to obtain optimum Film performance generally depends on the particular service environment and part geometry. For a strictly concave surface, the thicker the Base Layer is, the better the durability of Structure with respect to initial adhesion and resistance to thermal and mechanical stress and shock. However, such a Film will have inferior abrasion resistance to one with a greater Top Layer thickness. In various embodiments, the Base Layer comprises about 5% to 95% of the thickness of the Top Layer.

As compared to the Top Layer, the lower the crystallinity, the higher the elongation and the lower the Shrinkage of the Base Layer, the more stresses the Film can absorb that are placed on the Structure during processing and field use. Because the Base absorbs most of the stresses that occur during processing, the Top can be fabricated from a rigid, abrasion resistant Layer. Relative to the Base Layer, the higher the crystallinity, Abrasion Resistance, and hardness of the Top Layer, the more resistant the Structure is to permeation, slurries, and fluid flow. Cracking and de-lamination will not occur under normal circumstances because the bond between the base and top coat is unbreakable by mechanical means due to the fact that the Top Layer and Base Layer comprise Compatible Systems.

In some embodiments of the present teachings, the Base Layer and/or Top Layer can be made to crosslink. In certain conditions, cross linking may be present. Additionally, Bottom and/or Top Layers may have inert or reactive binders which dissapear or remain in the coating after processing.

In some embodiments, an Additional Layer or Top Coat is added over the Top Layer. The Additional Layer can comprise a non-Compatible System and can be used to modify chemical resistance, solvent and gas permeation, and hardness. One such example is an A-PEKK Base Layer, under a PEEK Top Layer which, in turn, is under a PFA Additional Layer.

The Film comprising the Layers may be produced by a variety of means, including the following representative examples: electrostatic coating, blow coating, dispersion coating, fluidized bed, flame spraying, plasma coating, roto-lining, roll forming, and extrusion. These processes preferably include the metal being prepared through heat cleaning and grit blasting. In some embodiments, it is preferable to utilize the application of a Coupling Agent. The coating process directly builds Coats into the Layers of the Film on the Substrate through techniques well know to those skilled in the art. The molding and extrusion processes directly inject single or multiple molten polymer(s) onto metal through techniques well known to those skilled in the art. The extrusion process can also produce a multi-layer lining in the form of a film, pipe, or tube that is bonded to the metal as a secondary step. In some embodiments, the Base Layer has a lower melting point than the Top Layer, and the Film is bonded to the Substrate at a temperature that melts the Base Layer but does not melt the Top Layer.

### DETAILED DESCRIPTION OF THE DRAWINGS

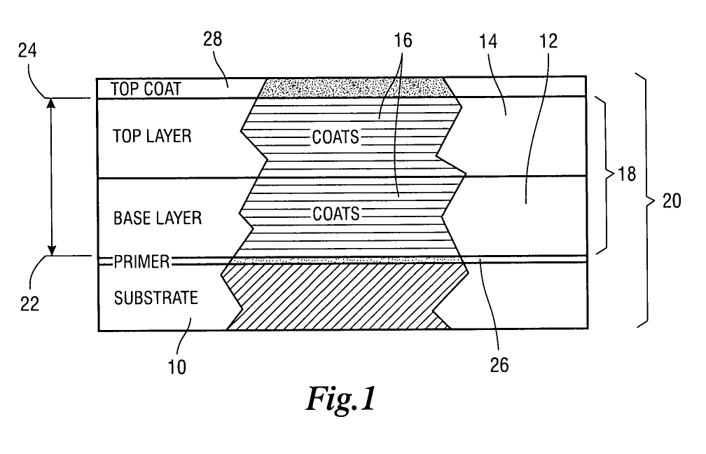

FIG. 1 depicts a Structure, 20, embodying the instant invention. The overall Structure, 20, is comprised of a Substrate, 10, to which is bonded a Base Layer, 12, which may be comprised of one or more Coats, 16. Bonded to the Base Layer is the Top Layer, 14, which also may consist of one or more Coats, 16. Both the Base Layer and Top Layer together comprise the Film, 18, protecting the Substrate, as said terms are defined herein. As the Coats are sequentially applied from the Substrate, the crystallinity of each Coat progressively increases from the Coat in contact with the Substrate, 22, (or primer coat) to the Top Coat of the Top Layer, 24. The Structure, 20, may also optionally include a primer layer, or Coupling Agent, 26, and/or a Top Coat, 28, as described herein.

### EXAMPLES

It will be readily understood that the following description of the embodiments of the present system, technique and method is not intended to limit the teachings herein.

### Example I

The PAEK-based coating comprising a Base Layer of A-PEKK and Top Layers of PEEK was compared against a standard monolayer PEEK coating by measuring the resistance to thermal cycles between a hot oven and ice water. The A-PEKK has very low Shrinkage (meaning 0.3% to 0.5% versus 0.7% to 1.0% for PEEK), twice the elongation to break (meaning 80% versus 40% for PEEK), but poor abrasion resistance compared to PEEK. Its crystallinity is less (meaning less than 15%) than PEEK, which is generally 25% to 30%. The A-PEKK is easy to apply to a wide range of geometries and part sizes and does not crack or delaminate as does PEEK. The A-PEKK/PEEK multi-layer coating is shown to have numerous advantages over a PEEK coating such as processability, durability to stresses, and excellent abrasion resistance. The present teachings utilize the ΔT, the number of test cycles, and definitions of pass/fail which are embodied in the sample preparation, test method, results, and conclusions sections set forth herein. Industry standard procedures for grit blasting, heat cleaning, and application procedure for electrostatic coatings were utilized. Oven cycle times, processing temperatures, gun settings, and coat weight/pass standards for the PEEK and A-PEKK layers that are well known in the art were utilized. For example, the inside of the pipe was electrostatically coated with a base layer of A-PEKK. This layer was between 5 mil-7 mil thick. The pipe was placed in an oven at 700° F. for 10 minutes to melt the polymer. Another layer, A-PEKK, was applied to bring the total Base Layer thickness to 10 mil. The inside of the pipe was then electrostatically coated with PEEK. Each pass was between 5-7 mil thick. The total PEEK coating was about 20 mils thick. After each pass, the system was placed in an oven at 750° F. for 20 minutes to melt the PEEK resin.

The standard PEEK coatings are referred to as coating “A.” The coat weight is designated immediately after in mils. For example “A-30” is a 30 mil PEEK coating, “A-40” is a 40 mil PEEK coating. The PAEK-based coating is referred to as coating “B.” The total Film thickness and Base Layer thickness were designated after the coating type. For example “B-30/10” is a PAEK-based coating 30 mil thick with a 10 mil Base Layer of A-PEKK. A 20 mil Top Layer of PEEK, “B-40/20,” is a PAEK-based coating with a 20 mil Base Layer of A-PEEK.

### Sample Preparation

Four inch (4″) diameter carbon steel pipes of one foot and two feet long were used as substrates to compare the performance of “A” and “B” coatings. Pipe sections were heat cleaned at 750° F. for three hours and then grit blasted internally using 36 grit aluminum oxide blasting adhesive. Samples were cleaned of any debris with compressed air.

Anchor profile measurements were made and recorded after blasting, indicating that a 5 mil-7 mil anchor had been achieved after blasting.

Control lots of three pipes each were processed with each coating. Each pipe section had a total coat weight between 20-45 mils. Coating thickness was achieved with three to seven coating passes (5-10 mils per pass).

### Test Method

Coated pipe sections were heated in a basket together inside an electric furnace for one hour. Pipe temperature was measured by using a Fluke 63 IR thermometer. The temperature of the sample was subsequently recorded.

A chilled water tank was created with 800 lbs of ice in a water bath. Bath temperature was controlled between 32° F.-60° F. The temperature of the water was recorded before immersion of the hot basket filled with pipes into the bath.

Heated pipe sections were taken directly from the hot furnace and dropped into the chill tank and totally immersed for 15 minutes. Baskets filled with the pipes were then removed from the bath.

All parts were inspected for failure. A failure was defined as either a de-lamination, or bubbling, or cracking of the coating from the inside surface of the pipe. De-lamination can occur axially or radially.

All passing samples were reloaded into the basket and removed to the oven for the next cycle. All failed samples were removed from the test. The number of samples and cycle at which a sample failed was recorded.

This procedure was repeated in two Tests. Test One was conducted on two foot pipe lengths. Test Two was conducted on one foot pipe sections. Table I provides a summary of the sample, coating, coat weight, oven temperature, time of samples in oven, water bath temperature, and time of samples in water bath.

TABLE I
Test Conditions.

| | | | | | Water | Water |
|---|---|---|---|---|---|---|
| | Pipe | | Oven | Oven | Bath | Bath |
| | Length | | Temp | Time | Temp | Time |
| Test | (ft) | Coatings | (° F.) | (min) | (° F.) | (min) |
| One | 2 | A-30, B-30/10 | 204-454 | 60 | 44-60 | 15 |
| Two | 1 | A-25, A-40, | 225-440 | 60 | 44-60 | 15 |
| | | B-25/10, B-35/10, | | | | |
| | | B-40/10 | | | | |

### Results

Test One consisted of 22 cycles between the water bath and heated oven. Cycles 1 through 10 had an average ΔT of 160° F. The lowest ΔT was 155° F. The highest ΔT was 188° F. ΔT is defined as the difference in temperature between the temperature measurement from the Fluke IR thermometer measured on the outer diameter of the sample pipe hanging off a rack outside the oven and the temperature of the ice bath measured by a thermometer immersed in the bath.

TABLE II
Test One on 2 Foot Long 4″ Pipe, 30 mil “A” and “B” Coatings.

| | Bath | Metal | | | |
|---|---|---|---|---|---|
| | Temp | Temp | ΔT | | |
| Cycle | (° F.) | (° F.) | (° F.) | Results | Failure Type |
| 1 | 56 | 231 | 175 | 1, “A-30” failure | Cracking |
| 2 | 54 | 233 | 179 | 1, “A-30” failure | Axial &radial |
| | | | | | de-lamination, cracking |
| 3 | 58 | 215 | 157 | 1, “A-30” failure | Axial &radial |
| | | | | | de-lamination, cracking |
| 4 | 65 | 222 | 157 | | |
| 5 | 57 | 217 | 160 | | |
| 6 | 48 | 236 | 188 | | |
| 7 | 60 | 220 | 160 | | |
| 8 | 44 | 204 | 160 | | |
| 9 | 48 | 212 | 164 | | |
| 10 | 59 | 215 | 156 | | |
| 11 | 44 | 243 | 199 | | |
| 12 | 47 | 244 | 197 | | |
| 13 | 35 | 243 | 208 | | |
| 14 | 41 | 250 | 209 | | |
| 15 | 40 | 263 | 223 | | |
| 16 | 40 | 260 | 220 | | |
| 17 | 41 | 244 | 203 | | |
| 18 | 41 | 255 | 214 | | |
| 19 | 42 | 247 | 205 | | |
| 20 | 40 | 280 | 240 | | |
| 21 | 43 | 315 | 272 | | |
| 22 | 57 | 454 | 397 | 3, “B-30/10” | Radial de-lamination |
| | | | | failures | |

All “A” coatings failed in cycles 1-3. The failure mechanism was de-lamination, cracking. De-lamination occurred both radially and axially. Cracking only occurred when the lip of the pipe was coated.

Cycles 11-20 had an average ΔT of 205° F. The lowest ΔT was 196° F. The highest ΔT was 222° F.

Cycle 21 had a ΔT of 271° F.

Cycle 22 had a ΔT of 391° F. All the “B” coatings failed under these conditions via radial de-lamination.

Test Two included samples that were one foot pipe sections. The samples consisted of a control lot of “A-25,” “A-40,” and “A-45” coatings and of samples “B.1-25/10,” “B.1-35/10,” and “B.1-40/10.”

TABLE III
Test Two on 1 Foot Long 4″ Pipe, “A” and “B” 25-40 mil Coatings.

| | Bath | Metal | | | |
|---|---|---|---|---|---|
| | Temp | Temp | ΔT | | |
| Cycle | (° F.) | (° F.) | (° F.) | Results | Failure Type |
| 1 | 34 | 226 | 192 | | |
| 2 | 40 | 229 | 189 | | |
| 3 | 40 | 223 | 183 | | |
| 4 | 39 | 235 | 196 | | |
| 5 | 39 | 235 | 196 | 1, A-45 failure | Radial de-lamination |
| 6 | 42 | 235 | 193 | | |
| 7 | 46 | 286 | 240 | 2, A-45 failure | Bubbling, radial |
| | | | | | de-lamination |
| 8 | 46 | 238 | 192 | 1, A-40 failure | Radial de-lamination |
| 9 | 51 | 308 | 257 | | |
| 10 | 55 | 282 | 227 | 1, A-40 failure | Radial de-lamination |
| 11 | 41 | 249 | 208 | 1, A-25 failure | Radial de-lamination |
| 12 | 42 | 290 | 248 | 1, A-40 failure | Radial de-lamination |
| 13 | 42 | 322 | 280 | | |
| 14 | 40 | 340 | 300 | 1, A-25 failure | Radial de-lamination |
| 15 | 39 | 367 | 328 | 1, A-25 failure | Radial de-lamination |
| 16 | 40 | 326 | 286 | 1, B-45/10 failure | Radial de-lamination |
| 17 | 52 | 395 | 343 | | |
| 18 | 46 | 396 | 350 | | |
| 19 | 49 | 360 | 311 | | |
| 20 | 56 | 386 | 330 | 2, B-45/10 failure | Radial de-lamination |
| 21 | 58 | 363 | 305 | | |
| 22 | 63 | 384 | 321 | | |
| 23 | 66 | 390 | 324 | 1, B-35/10 failure | Radial de-lamination |
| 24 | 71 | 316 | 245 | 1, B-35/10 failure | Radial de-lamination |
| 25 | 44 | 313 | 269 | 1, B-35/10 failure | Radial de-lamination |
| 26 | 40 | 360 | 320 | | |
| 27 | 38 | 300 | 262 | | |
| 28 | 39 | 400 | 361 | | |
| 29 | 39 | 340 | 301 | | |
| 30 | 39 | 358 | 319 | | |
| 31 | 40 | 381 | 341 | | |
| 32 | 40 | 343 | 303 | | |
| 33 | 41 | 385 | 344 | | |
| 34 | 42 | 390 | 348 | | |
| 35 | 44 | 326 | 282 | | |
| 36 | 47 | 308 | 261 | | |
| 37 | 50 | 385 | 335 | | |
| 38 | 52 | 358 | 306 | | |
| 39 | 53 | 330 | 277 | | |
| 40 | 55 | 417 | 362 | | |
| 41 | 42 | 342 | 300 | | |
| 42 | 42 | 342 | 300 | | |
| 43 | 40 | 360 | 385 | | |
| 44 | 40 | 425 | 344 | | |
| 45 | 41 | 385 | 324 | No B-25/10 failures | |

Cycles 1-7 had an average ΔT=198° F. All the 45 mil thick “A” coatings failed in this range.

Cycles 7-15 had an average ΔT=266° F. The 25 and 40 mil thick “A” coatings failed in this range.

Cycles 16-25 had an average ΔT=317° F. The 35 and 45 mil “B” coatings failed in this range.

Test Two was stopped at 45 cycles. None of the 25 mil B coatings failed.

### Conclusions

The experiments set forth herein show that during processing and use of PEEK coatings:
(i) Large radial and axial stresses are created due to processing temperatures, shrinkage induced by crystallization, and CLTE mismatch between the coating and metal substrate.
(ii) Lack sufficient adhesion to remain bonded to the inner metal surface for more than a few cycles where the temperature changes 200° F.
(iii) Develop cracks when the lip of pipe was coated due to thermal expansion mismatch between the coating and metal substrate.

The PAEK-based “B” coatings showed substantially improved resistance to thermal shock than PEEK monolayer coatings at equivalent total coat weight thickness. For example, a 30 mil PAEK coating can withstand indefinite thermal cycles of 200° F.; whereas a PEEK coating can withstand a maximum of three of the same cycles on a 4″ diameter, 2 ft long carbon steel pipe. Additionally, the PAEK-based coating was shown to be able to withstand cycles over 300° F. Another example, on a 4″ diameter, 1 ft long carbon steel pipe showed that a 25 mil PAEK-based coating can withstand at least 25 thermal cycles of 300° F.; whereas PEEK can not survive a single cycle.

The PAEK-based coatings improve resistance to axial de-lamination. The Bayer Layer of the PAEK coating is more ductile than PEEK alone. As a result of this, and low shrinkage from solidification, a PAEK based coating of equivalent coat weight will stay adhered to large, concave surfaces (e.g., long pipe sections) in contrast to PEEK alone. The Bayer Layer absorbs the mechanical stress caused by bending and CLTE polymer-metal mismatch more effectively than PEEK alone, which is more rigid, has lower elongation to break, and high shrink from solidification.

The durability of the PAEK-based coating is a function of the ratio of Top Layer to Base Layer. The thicker the Base Layer is compared with the Top Layer, the greater the resistance to mechanical and thermal stress. The thicker the Base Layer is compared to the Top Layer, the lower the resistance to abrasion compared to the Top Layer alone.

The ratio of Top Layer to Base Layer should be chosen based on part geometry. PAEK-based coatings are especially useful for improving the durability to mechanical and thermal stress on Concave Surfaces. In the case of pipes, it is preferable that about 10% to 40% of the total coat weight comprises the Base Layer. The smaller the diameter of the pipe is, the greater the ratio of Base Layer to Top Layer. For a 2 inch diameter pipe, a 35-40% Base Layer is preferable. For a 4″ diameter pipe, a 20-40% Base Layer is preferable. For an 8″ diameter or larger pipe, a 10-15% Base Layer is preferable.

### Example II

### Increased Adhesion by Use of Coupling Agent.

Pipe sections made from carbon steel 4″ diameter and 2″ long were prepared for coating by heat cleaning and grit blasting.

Pipe sections were wiped with an alcohol-water solution containing 2% of a high temperature silane with a functional group that interacts with A-PEKK. The silane was cured by heating for 20 minutes at 110° F. After curing, the silane chemically reacts with the metal substrate to form an enhanced corrosion barrier. This corrosion barrier further retards solvents and gases from permeating to the metal surface. As a consequence, the initial strength of adhesion is retained for longer periods of time in these environments.

Three sample coatings were prepared: (1) PEEK, (2) PEEK/A-PEKK, and (3) PEEK/A-PEKK/coupling agent. The Shrinkage, elongation to break, and the crystallinity of the materials is the same as for Example I. The total coating thickness of each coating was 25 mil. The A-PEKK layer was 35% of the total coating thickness.

Each of the coatings was scratched with a nail to expose the metal substrate.

The pipe sections where immersed in boiling water until de-lamination occurred due to water seepage under the coating in the area where it had been damaged by the nail, physically disbanding the coating. The number of hours to failure was recorded.

The PEEK coatings delaminated first at 10 hours. The PEEK/A-PEKK coatings delaminated next at 40 hours. The PEEK/A-PEKK/coupling agent system failed last at 60 hours.

### Example III

### Evidence of Improved Coating Quality from A-PEEK/PEEK Compared to Traditional PEEK Coating

A-PEEK/PEEK and PEEK were electrostatically coated to a total coating thickness of 10 mils on pieces of metal bent at 90° in the same manner as provided in Example I. The Shrinkage, elongation to break, and the crystallinity of the materials is the same as for Example I.

After cooling to room temperature the A-PEEK/PEEK structure was compared to the traditional PEEK coatings. The A-PEEK/PEEK structure showed no visible pin holes through visual observation and through 50,000V spark test inspection. The standard PEEK coating had large, visible pin holes around the bend caused by movement of the polymer caused by high shrinkage and low elongation of the PEEK coating away from bend during solidification.

### Example IV

### Bonding A-PEKK/PEEK Film to Metal Through Secondary Application of Heat and Pressure

An A-PEKK/PEEK film was extruded where the A-PEKK layer was 1 mil thick and the PEEK layer was 5 mil thick. The Shrinkage, elongation to break, and the crystallinity of the materials is the same as for Example I. The film was placed on a de-greased aluminum sheet. The film-metal system was placed between two heavy, flat steel plates and placed in a press and heated to 635° F. Because the processing temperature is below the melt temperature for the semi-crystalline PEEK layer, the PEEK layer does not melt. The processing temperature is above the melt temperature of the amorphous A-PEKK layer which softens and bonds to the metal.

### Example V

### Use of A-PEEK/PEEK Structure as a Tie Layer to Fluoropolymer-Metal Coatings

PEEK is occasionally used as a base coat for thick, porous fluoropolymer coatings such as PTFE because it has better adhesion and lower permeation to solvents than the porous fluoropolymers. Better adhesion and lower permeation improve the durability and corrosion resistance versus simply coating vessels with PTFE.

Use of A-PEKK/PEEK instead of PEEK improves adhesion of the polyketone layer to the metal. A comparison of the permeation of solvents and gases through the polymers is as follows: PEEK<A-PEKK<<PTFE. Use of A-PEKK/PEEK improves coating quality by eliminating pin holes, cracking, and de-lamination of vessel and pipe internals due to shrinkage when the PEEK layer crystallizes.

### Example VI

### Use of Compounds to Enhance Properties of A-PEEK and PEEK Layers in Coatings

Organic or inorganic particulate, fiber, and plate-like reinforcements can be added to the A-PEKK and PEEK layers to enhance the properties thereof. For example, the abrasion resistance of the A-PEKK Base Layer can be improved through addition of glass powders and fibers, ceramic fillers, carbon fibers, stainless steel powders, and the like. In addition to improving abrasion resistance, the fillers further reduce shrinkage of polymer from melt and promote adhesion to metal. Similar fillers can be added to the PEEK Top Layers to reduce coefficient of friction, lubricity, CLTE, and shrinkage. Such fillers can include, for example, PTFE, PFA, MoS₂, WS₂, BN, and SiC.

### Example VII

### Compatible Coats

In addition to A-PEKK and PEEK, there are other Systems of the present teachings that can form consecutive Compatible Coats within a Layer. Table IV lists representative examples. Compatible Coats are formed when each respective Coat is made from the same Polymer family or is at least partially miscible. However, progressive Coats must be progressively of equal or greater Shrinkage, and more preferably equal or greater crystallinity, to be within the instant invention.

TABLE IV
Examples of Compatible Coats.

| Coat #1 | Coat #2 | |
|---|---|---|
| Composition | Composition | Comments |
| A-PEKK | C-PEKK | A-PEKK and C-PEKK are in the same |
| | | Polymer family and are miscible. |
| A-PEKK/TPI | C-PEKK | A-PEKK and TPI form a miscible blend. |
| PEEK/PEI | PEEK | PEEK and PEI form a miscible blend. |
| PEEK/PES | PEEK | PEEK and PES form an immiscible blend; |
| | | however the PEEK from each coat bonds |
| | | to itself. |
| A-PEKK/PBI | A-PEKK | A-PEKK and PBI are partially miscible. |

The section headings used herein are for organizational purposes only and are not to be construed as limiting the subject matter described in any way.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

What is claimed is:

1. A structure for protecting a surface, comprising:
(a) a film comprising a top layer and a base layer subjacent the top layer, said top layer having a higher elongation to breakage than the base layer, and said top layer having a higher crystallinity than the base layer, and
(b) the film being bonded to a substrate.

2. The structure of claim 1, wherein the substrate comprises a metal.

3. The structure of claim 1, wherein the substrate comprises a metal including an inorganic layer on a surface thereof.

4. The structure of claim 2, wherein the metal comprises a ferrous material, steel, or iron.

5. The structure of claim 2, wherein the metal comprises a non-ferrous material, aluminum, or titanium.

6. The structure of claim 3, wherein the inorganic layer comprises a thickness of less than about 0.5 mil.

7. The structure of claim 3, the metal further including one or more functional groups disposed on a surface thereof, the inorganic layer being configured to chemically react with said one or more functional groups.

8. The structure of claim 1, wherein the film further comprises a layer superadjacent the top layer, said superadjacent layer having a lower abrasion resistance than said top layer.

9. The structure of claim 1, wherein the base layer comprises a lower melting point than the top layer.

10. The structure of claim 1, wherein the base layer, the top layer, or the base and top layers further comprise melting or non-melting inorganic fillers up to 40 w/w %.

11. The structure of claim 1, wherein the film comprises a thickness between about 1 mil and 2500 mil.

12. The structure of claim 1, wherein said top and base layers further comprise one or more inert binders or one or more reactive binders.

13. The structure of claim 1, wherein said top and base layers comprise a crosslinked configuration for attachment of said layers.

14. The structure of claim 1, said top and base layers being attached through a covalent bonding or a mechanical bonding configuration disposed between a melt interface of said layers.

15. The structure of claim 1, wherein said top and base layers further comprise at least partial miscibility, a melt temperature differential being equal to or less than about 150° F., a tensile strength at ambient temperature being equal to or less than about 50%, and an elongation differential at ambient temperature being equal to or less than about 200%.

16. The structure of claim 15, said polymer or said blend further including an inorganic filler.

17. The structure of claim 15, said polymer or said blend further including inorganic fillers being less than or equal to about 40 w/w %.

18. The structure of claim 15, said polymer or said blend comprising a melting point above about 550° F. and a UL RTI rating being equal to or greater than about 450° F.

19. A method for protecting a surface, comprising:
employing a film having a top layer and a base layer subjacent the top layer, said top layer having a higher crystallinity than the base layer, and said base layer having a higher elongation to breakage; and
applying said film to a substrate;
said base layer having a lower melting point than said top layer such that a processing temperature for said attachment step is sufficient to melt the base layer onto the substrate but not to melt the top layer.
